(19) United States
(12) Patent Application Publication
(10) Pub. No.: US 2024/0394480 A1
(43) Pub. Date: Nov. 28, 2024

(54) PREDICTING AND MITIGATING CONTROVERSIAL LANGUAGE IN DIGITAL COMMUNICATIONS

(71) Applicant: INTERNATIONAL BUSINESS MACHINES CORPORATION, ARMONK, NY (US)

(72) Inventors: PAULO RODRIGO CAVALIN, RIO DE JANEIRO (BR); Ana Paula Appel, São Paulo (BR); Alecio Pedro Delazari Binotto, Munich (DE)

(21) Appl. No.: 18/323,374

(22) Filed: May 24, 2023

(51) Int. Cl. G06F 40/35; G06F 40/40

(52) U.S. Cl. CPC G06F 40/35; G06F 40/40

(57) ABSTRACT

An embodiment for improved predicting and mitigating of controversial language in digital communications. The embodiment may detect language within a candidate communication associated with a user and a corresponding user network. The embodiment may interpret the detected language to identify a series of predetermined controversial traits. The embodiment may calculate an impact risk score for the candidate communication by using a graph neural network to leverage historical data within an accessible knowledge base, wherein the impact risk score is based on risk associated with the detected language and the corresponding user network. The embodiment may, in response to detecting the calculated impact risk score for the candidate communication is above a predetermined threshold value, automatically identify suitable replacement language. The embodiment may generate and output to the user one or more substitute communications including the identified suitable replacement language.

### BACKGROUND

The present application relates generally to computer processing, and more particularly, to improved predicting and mitigating of controversial language in digital communications.

Digital communication across various online platforms and social media websites has quickly become one of the most common ways in which people communicate and participate in societal discourse. The immediacy and scale of social media communication can sometimes allow for harmful or divisive language to spread quickly and have significant real-world consequences. For this reason, many businesses who own and run various online platforms and social media websites seek to preemptively moderate their content by mitigating controversial language to promote responsible and respectful online communication in order to create the most inclusive and equitable digital space for their users and customers.

### SUMMARY

According to one embodiment, a method, computer system, and computer program product for improved predicting and mitigating of controversial language in digital communications is provided. The embodiment may include detecting language within a candidate communication associated with a user and a corresponding user network. The embodiment may also include interpreting the detected language to identify a series of predetermined controversial traits. The embodiment may further include calculating an impact risk score for the candidate communication by using a graph neural network to leverage the identified series of predetermined controversial traits and historical data within an accessible knowledgebase, wherein the impact risk score is based on risk associated with the detected language and the corresponding user network. The embodiment may also include in response to detecting the calculated impact risk score for the candidate communication is above a predetermined threshold value, automatically identifying suitable replacement language for one or more controversial portions of the candidate communication. The embodiment may further include generating and outputting to the user one or more substitute communications including the identified suitable replacement language.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an operational flowchart for an exemplary process of predicting and mitigating controversial language in digital communications according to at least one embodiment;

FIG. 3 illustrates exemplary system architecture of an illustrative controversial language mitigation program capable of predicting and mitigating controversial language in digital communications according to at least one embodiment;

FIG. 4 illustrates a flow chart of an exemplary process for building a knowledge usable by an illustrative controversial language mitigation program capable of predicting and mitigating controversial language in digital communications according to at least one embodiment; and

FIG. 5 illustrates a flow chart and graphical depictions of an exemplary process for identifying suitable replacement language for one or more controversial portions of a candidate communication according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present application relate generally to computer processing, and more particularly, to improved predicting and mitigating of controversial language in digital communications. The following described exemplary embodiments provide a system, method, and program product to, among other things, detect language within a candidate communication associated with a user and a corresponding user network, interpret the detected language to identify a series of predetermined controversial traits, and calculate an impact risk score for the candidate communication by using a graph neural network to leverage the identified series of predetermined controversial traits and historical data within an accessible knowledgebase, wherein the impact risk score is based on risk associated with the detected language and the corresponding user network. Described embodiments may then, in response to detecting the calculated impact risk score for the candidate communication is above a predetermined threshold value, automatically identify suitable replacement language for one or more controversial portions of the candidate communication, and then generate and output to the user one or more substitute communications including the identified suitable replacement language. Therefore, the presently described embodiments have the capacity to improve predicting and mitigating of controversial language in digital communications by leveraging predictive artificial intelligence (AI) and machine learning models to alert users about predicted controversial language, while also actively mitigating the use of the controversial language by identifying suitable replacement language and generating substitute communications that a user may optionally choose to publish in place of the candidate message containing the predicted controversial language. Described embodiments may further provide users with explainability related to the predicted controversial language based on information from an accessible knowledgebase that leverages language features as well as a user's network-specific features that may vary based on language, culture, or environment. Described embodiments may further incorporate feedback modules to leverage user feedback as validation or as a negative example to improve future performance of the applicable models.

As previously described, digital communication across various online platforms and social media websites has quickly become one of the most common ways in which people communicate and participate in societal discourse. The immediacy and scale of social media communication can sometimes allow for harmful or divisive language to spread quickly and have significant real-world consequences. For this reason, many businesses who own and run various online platforms and social media websites seek to preemptively moderate their content by mitigating controversial language to promote responsible and respectful online communication in order to create the most inclusive and equitable digital space for their users and customers.

However, there are many challenges related to preemptively moderating online communication. For example, in some instances, a candidate communication written by a user may include language that is controversial in one language or within one user network, but not in another. Thus, a user's network may affect the negative impact risk of a given candidate communication. In some instances, even if a user's candidate communication is identified as controversial, no substitute language is provided, increasing the likelihood that the user either posts the controversial language, or disengages from the platform. In other instances, a candidate message may be flagged as including controversial language without any explainability provided to the user, negatively affecting the user experiences of users on the involved platform. For a business running any type of social media or online communication platform, preemptively moderating content while maintaining a positive user experience to ensure inclusive and equitable digital space for their users is a high priority.

Accordingly, a method, computer system, and computer program product for improved predicting and mitigating of controversial language in digital communications would be advantageous. The method, system, and computer program product may detect language within a candidate communication associated with a user and a corresponding user network. The method, system, computer program product may interpret the detected language to identify a series of predetermined controversial traits. The method, system, computer program product may then calculate an impact risk score for the candidate communication by using a graph neural network to leverage the identified series of predetermined controversial traits and historical data within an accessible knowledgebase, wherein the impact risk score is based on risk associated with the detected language and the corresponding user network. The method, system, computer program product may then, in response to detecting the calculated impact risk score for the candidate communication being above a predetermined threshold value, automatically identify suitable replacement language for one or more controversial portions of the candidate communication. Thereafter, the method, system, computer program product may generate and output to the user one or more substitute communications including the identified suitable replacement language. In turn, the method, system, computer program product has provided for improved predicting and mitigating of controversial language in digital communications by leveraging predictive AI and machine learning models to alert users about predicted controversial language, while also actively mitigating the use of the controversial language by identifying suitable replacement language and generating substitute communications that a user may optionally choose to publish in place of the candidate message containing the predicted controversial language. Described embodiments may further provide users with explainability related to the predicted controversial language based on information from an accessible knowledgebase that leverages language features as well as a user's network-specific features that may vary based on language, culture, or environment. Described embodiments may further incorporate feedback modules to leverage user feedback as validation or as a negative example to improve future performance of the applicable models.

The present invention may be a system, a method, and/or a computer program product at any possible technical detail level of integration. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

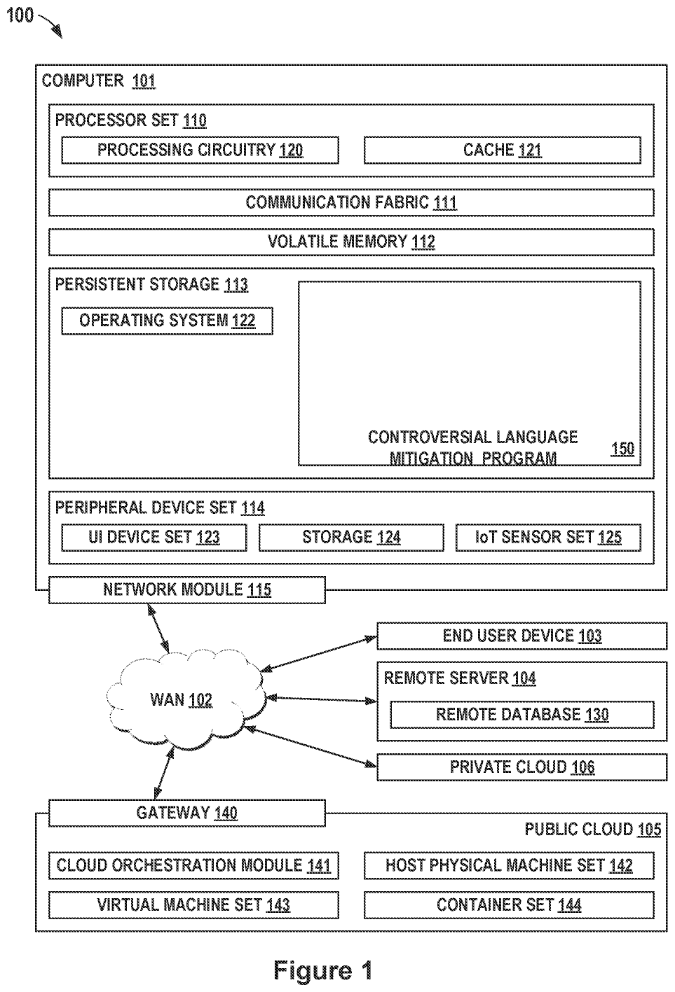

Referring now to FIG. 1, computing environment 100 contains an example of an environment for the execution of at least some of the computer code involved in performing the inventive methods, such as controversial language mitigation program/code 150. In addition to controversial language mitigation code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and controversial language mitigation code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in controversial language mitigation code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in controversial language mitigation program 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the controversial language mitigation program 150 may be a program capable of detecting language within a candidate communication associated with a user and a corresponding user network. Controversial language mitigation program 150 may then interpret the detected language to identify a series of predetermined controversial traits. Next, controversial language mitigation program 150 may calculate an impact risk score for the candidate communication by using a graph neural network to leverage the identified series of predetermined controversial traits and historical data within an accessible knowledgebase, wherein the impact risk score is based on risk associated with the detected language and the corresponding user network. Controversial language mitigation program 150 may then, in response to detecting the calculated impact risk score for the candidate communication being above a predetermined threshold value, automatically identify suitable replacement language for one or more controversial portions of the candidate communication. Thereafter, controversial language mitigation program 150 may generate and output to the user one or more substitute communications including the identified suitable replacement language. In turn, controversial language mitigation program 150 has provided for improved predicting and mitigating of controversial language in digital communications by leveraging predictive AI and machine learning models to alert users about predicted controversial language, while also actively mitigating the use of the controversial language by identifying suitable replacement language and generating substitute communications that a user may optionally choose to publish in place of the candidate message containing the predicted controversial language. Described embodiments may further provide users with explainability related to the predicted controversial language based on information from an accessible knowledgebase that leverages language features as well as a user's network-specific features that may vary based on language, culture, or environment. Described embodiments may further incorporate feedback modules to leverage user feedback as validation or as a negative example to improve future performance of the applicable models.

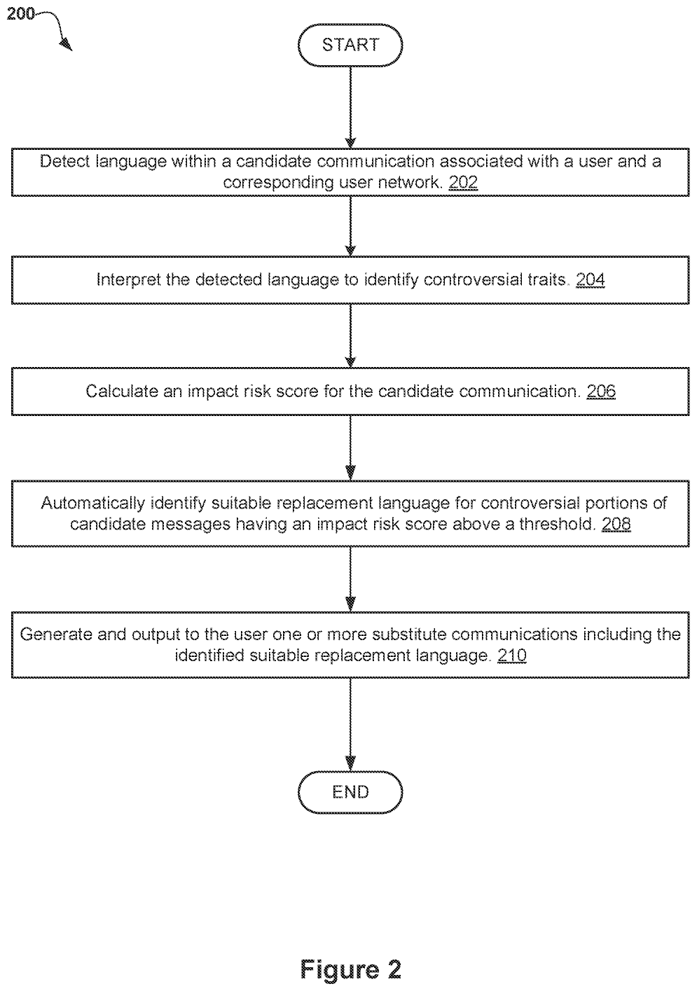

Referring now to FIG. 2, an operational flowchart for an illustrative process 200 of improved predicting and mitigating of controversial language in digital communications according to at least one embodiment is provided.

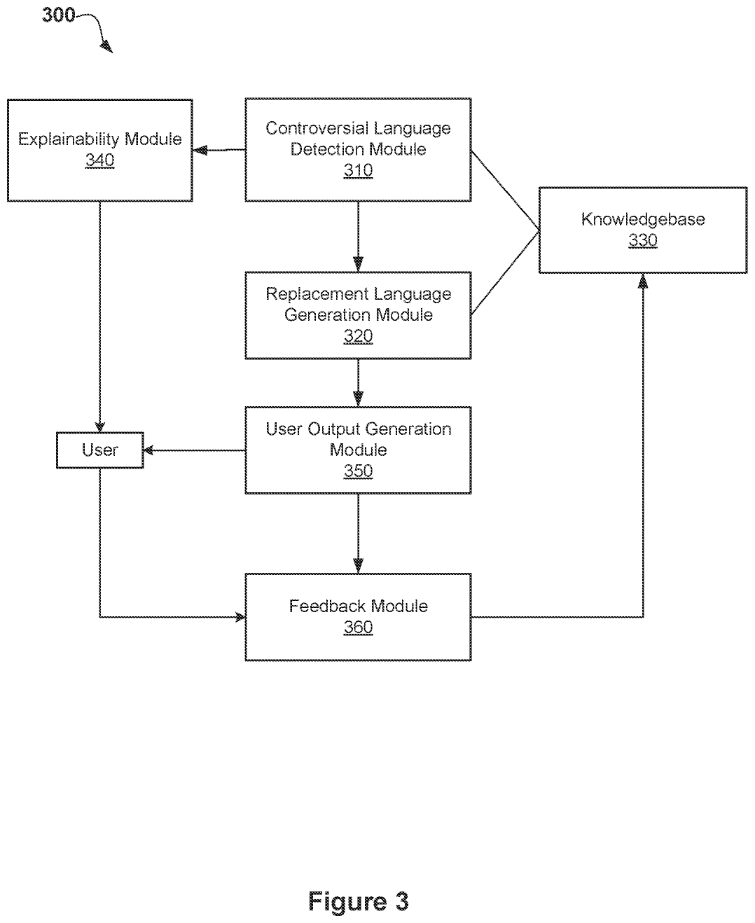

FIG. 3 illustrates exemplary system architecture 300 of an illustrative controversial language mitigation program 150 capable of predicting and mitigating controversial language in digital communications according to at least one embodiment. The exemplary system architecture 300 depicted in FIG. 3 includes a controversial language detection module 310 and a replacement language generation module 320 configured to leverage an accessible knowledgebase 330. Exemplary system architecture 300 further includes an explainability module 340, a user output generation module 350, and a feedback module 360 configured to provide feedback data to the knowledgebase 330. Exemplary system architecture 300 will be referenced and described in greater detail throughout the description of illustrative process 200 below.

Returning to FIG. 2 and the illustrative process 200, at 202, controversial language mitigation program 150 may detect language within a candidate communication associated with a user and a corresponding user network. In embodiments, for example, controversial language mitigation program 150 may be employed by any digital communication platform to preemptively moderate any candidate communications or content drafted by users before they are published. Accordingly, at this step, controversial language mitigation program 150 may utilize a controversial language detection module 310 to first detect any candidate communications associated with a given user, as well as the corresponding user network that is associated with that user. For example, at this step controversial language detection module 310 of controversial language mitigation program 150 may detect language within a candidate communication drafted by an exemplary user ‘U1’ that states ‘Greatest day in the history of mankind’. Controversial language detection module 310 of controversial language mitigation program 150 may further detect that exemplary user ‘U1’ is part of a corresponding user network ‘N’.

Next, at 204, controversial language mitigation program 150 may interpret the detected language to identify a series of predetermined controversial traits. At this step, controversial language mitigation program 150 utilizes controversial language detection module 310 to interpret the words, sentences, scenes, and other features of the detected language. In embodiments, controversial language detection module 310 of controversial language mitigation program 150 may, for example, be configured to utilize any suitable text classification techniques or entity extraction and named entity recognition (NER) techniques. In embodiments, controversial language detection module 310 may be further configured to employ neuro-symbolic approaches for text-based policy learning, latent Dirichlet allocation (LDA) models, or any other suitable Bayesian topic models to analyze text and images in the detected language to identify a series of predetermined controversial traits. The predetermined controversial traits may be stored within an accessible knowledgebase 330 to which controversial language detection module 310 of controversial language mitigation program 150 has access. Predetermined controversial traits may include certain words, phrases, or even images, video, photographs, or sounds, that are associated with controversial posts contained in the accessible knowledgebase 330. Predetermined controversial traits may further include features associated with controversial language or controversial posts such as receiving more dislikes than likes, higher levels of negative sentiment than positive sentiment, and higher volumes of opposing comments than positive comments, or any other features indicative of a controversial communication. The building of an exemplary knowledgebase will be described in greater detail below.

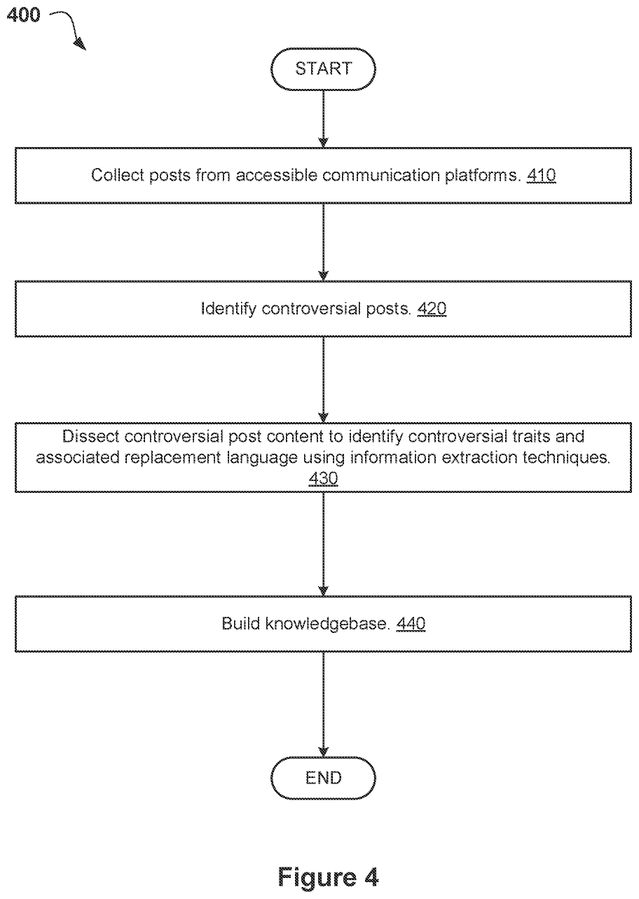

In embodiments, a suitable knowledgebase 330 may be built by processing large amounts of historical data including communications, associated comments, and user interactions. For example, in embodiments an exemplary knowledgebase 330 may include historical posts, associated user comments, and data on user interactions such as likes or dislikes. This historical data may be leveraged by controversial language mitigation program 150 to identify candidate messages that include detected language that is at high risk of being controversial by comparing the candidate messages to a series of relevant historical controversial communications or posts. FIG. 4 illustrates a flow chart of an exemplary process 400 for building a knowledge usable by an illustrative controversial language mitigation program 150 capable of predicting and mitigating controversial language in digital communications according to at least one embodiment. In a first step at 410, posts or digital communications are collected from one or more accessible communication platforms. Next at 420, a series of controversial posts or communications may be identified, for example, by finding posts that include higher levels of negative sentiment than positive sentiment, and higher volumes of opposing comments than positive comments, or any other features that may be associated with a negatively received or controversial communication. At 430, the identified series of controversial posts or communications may then be dissected to identify the specific controversial language contained therein by using known language and information extraction techniques discussed above. The identified controversial language may then be used to build a knowledgebase at 440 containing identified controversial posts and communications, associated data, and corresponding predetermined controversial traits related to the posts and communications. As discussed above the stored predetermined controversial traits may include extracted controversial language (in the form of words, phrases, or other types of communication like pictures, sound, video, etc.) and controversial features associated with a given post or communication. Thus, at 204, controversial language mitigation program 150 may then leverage the knowledgebase as it interprets received language to determine if the received language includes any of the predetermined controversial traits stored within the accessible knowledgebase. At later steps of illustrative process 200, discussed in greater detail below, word and sentence embeddings may be used to identify similar language that may serve as suitable replacement language for the identified controversial language. The suitable replacement language may also be stored within the knowledgebase.

Returning to the example above, at step 204, controversial language detection module 310 of controversial language mitigation program 150 may interpret the detected language drafted by user ‘U1’ which states ‘Greatest day in the history of mankind’ to identify a series of predetermined controversial traits. Controversial language detection module 310 of controversial language mitigation program 150 may then leverage the above-described text classification techniques to leverage an accessible knowledgebase 330 to compare the language of the candidate message to the historical post data within the knowledgebase 330. In this example, knowledgebase 330 may include a series of historical posts in which the phrase ‘mankind’ is associated with predetermined controversial traits such as relating to communications having higher quantities of dislikes than likes, relating to communications including higher levels of negative sentiment than positive sentiment, relating to communications with higher volumes of opposing comments than positive comments, etc. Controversial language mitigation program 150 would thus identify each of the described predetermined controversial traits which may be leveraged to help determine the likelihood that ‘mankind’ will result in a candidate communication being controversial.

Next, at 206, controversial language mitigation program 150 may calculate an impact risk score for the candidate communication by using a graph neural network to leverage the identified series of predetermined controversial traits and historical data within an accessible knowledgebase, wherein the impact risk score is based on risk associated with the detected language and the corresponding user network. In other words, controversial language mitigation program 150 will determine based on the identifies series of predetermined controversial traits and the historical data in the knowledgebase, a score reflecting the extent to which the detected language in the candidate message is likely to be controversial based on the language and the user network in which the candidate message would be posted. At this step controversial language detection module 310 of controversial language mitigation program 150 may be configured to leverage a graph neural network (GNN) to make this determination. For example, an exemplary GNN may analyze the sentiment and semantic content of the detected language in the candidate message and compare it with the historical controversial posts in knowledgebase 330. The exemplary GNN may then identify the clusters or groups of nodes that may be affected by the detect language and calculate an impact risk score and its potential impact on the applicable user network. The calculated impact risk score may be further affected by a wide variety of additional factors related to the detected language and the user network. For example, in embodiments, the impact risk score may be affected based on considering user ego networks, user profiles, post topics and categories, and the text or images that the user has posted. This addresses challenges related to certain candidate messages having a high risk of being controversial in certain networks based on language, culture, etc., but not necessarily having a high risk of being controversial in a separate network. In embodiments, the determined impact score may be represented numerically and normalized to be more user friendly for purposes of outputting explainability statements. For example, language mitigation program 150 may calculate and output an impact risk score between 0 and 1, where numbers closer to 1 indicate higher relative impact risk associated with controversial language. Returning to the example above, at this step, controversial language detection module 310 of controversial language mitigation program 150 may leverage a GNN to calculate an impact risk score of 0.9 for the candidate message drafted by user ‘U1’ which states ‘Greatest day in the history of mankind’. This would indicate that based on the historical data in knowledgebase 330, the detected language in the candidate message and the features of the user network indicate that the candidate message would pose a relatively higher risk of being controversial based on the detected language likely including controversial language and the associated user network having features that indicate the detected language is likely viewed negatively in that network.

In embodiments, controversial language mitigation program 150 may further include an explainability module 340 which may be configured to collect information related to the identified series of predetermined controversial traits at 204, and information associated with the calculated impact risk scores at 206 (risk score, network features, etc.) such that the explainability module 340 may subsequently output and display explanations to the user about why their candidate message may include controversial language. Explainability module 340 may output or display the explanations to the user in any suitable format (text, PDF, image, etc.) through any suitable channels. For example, the explanations may be sent directly through the applicable social media or communication platform, an associated application, via email, or any other suitable communication mechanism or channel.

At 208, controversial language mitigation program 150 may then, in response to detecting the calculated impact risk score for the candidate communication being above a predetermined threshold value, automatically identify suitable replacement language for one or more controversial portions of the candidate communication. In other words, controversial language mitigation program 150 identifies whether the risk of a candidate message being controversial in nature is large enough to justify active mitigation via identifying suitable replacement language and subsequently generating and outputting substitute communications to the user, as will be discussed in greater detail at step 210. In embodiments, the predetermined threshold value may be adjusted as desired depending on the communication platform and an associated desired level of moderation. For example, for a communication platform that is professional or academic in nature, the predetermined threshold value may be decreased causing controversial language mitigation program 150 to identify suitable replacement language for an increasing number of controversial portions of candidate communications that have associated calculated impact risk scores below the predetermined threshold value, and to subsequently generate and output larger numbers of corresponding substitute communications including the suitable replacement language.

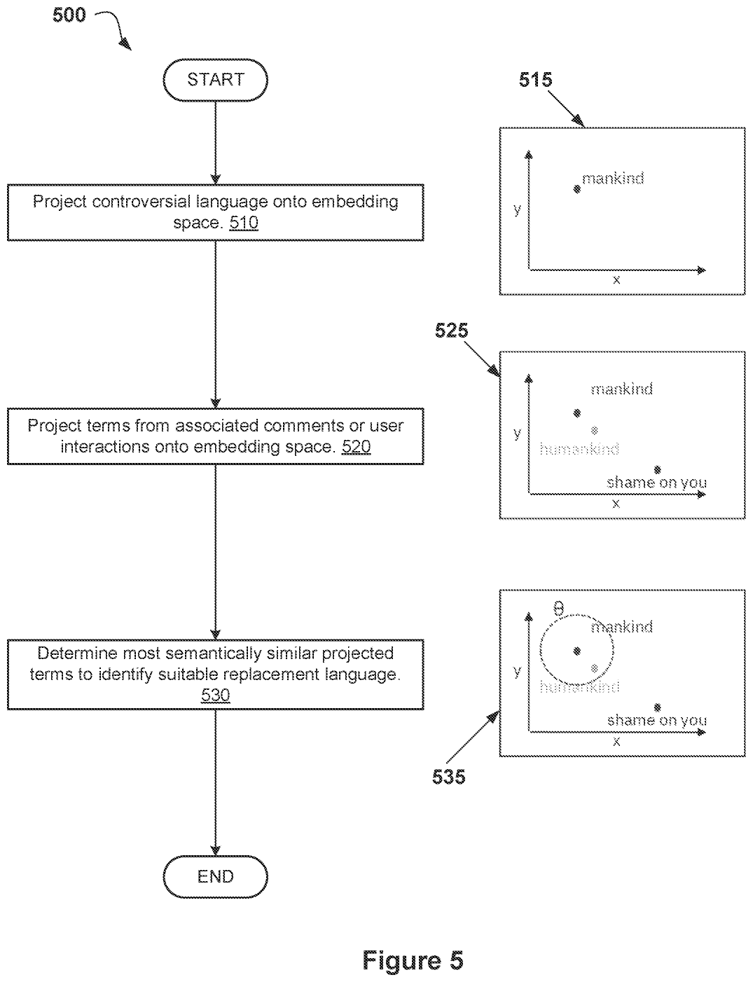

In embodiments, controversial language mitigation program 150 may utilize an exemplary replacement language generation module 320 to identify the suitable replacement language for one or more controversial portions of the candidate communication. In embodiments, replacement language generation module 320 may be configured to determine suitable replacement language based on sentiment analysis and/or topic classification to detect posts and comments with controversial language and suggested non-controversial language. In some embodiments, replacement language generation module 320 may be configured to generate embeddings associated with language in the controversial portions of the detected language. For example, replacement language generation module 320 may leverage Word2Vec, Global Vectors (GloVe), Bidirection Encoder Representations from Transformers (BERT), and Visual Bidirection Encoder Representations from Transformers (VisualBERT) models, and any other suitable tools and techniques to help determine suitable replacement language based on word and sentence embeddings. In embodiments, the controversial portions of detected language, and terms in associated comments may be projected in an embedding space. Replacement language generation module 320 may then find semantically similar suggested terms with a threshold e and based on Euclidean distance. For example, returning to the example candidate message discussed above in which a user ‘U1’ drafts a candidate message “Greatest day in the history of mankind”, if controversial language mitigation program 150 calculates that the impact risk score for this candidate message is above the predetermined threshold value, then replacement language generation module 320 will identify the suitable replacement language for one or more controversial portions of the candidate communication. This example is depicted in process 500 of FIG. 5. In this case, the controversial portion of the candidate message may be the word ‘mankind’. Language generation module 320 of controversial language mitigation program 150 may then utilizes suitable tools and techniques as referenced above to project the term ‘mankind’ onto an embedding space at 510. Next at 520, replacement language generation module 320 of controversial language mitigation program 150 may then project terms from associated comments or user interactions (accessible via knowledgebase 330) onto the embedding space. For example, the word ‘humankind’ and the phrase ‘shame on you’, taken from associated comments that are related to the word ‘mankind’, may be projected onto the embedding space. Thereafter, at 530, replacement language generation module 320 may then determine which of the projected words or phrases are most semantically similar to the controversial portion of the detected language, and may therefore serve as suitable replacement language. Each of steps 510. 520, and 530 are depicted graphically in FIGS. 5 at 515, 525, and 535 respectively. In this instance, ‘humankind’ would be the most semantically similar, and would therebefore be identified by language generation module 320 of controversial language mitigation program 150 as suitable replacement language for the word ‘mankind’.

Thereafter, at 210, controversial language mitigation program 150 may generate and output to the user one or more substitute communications including the identified suitable replacement language. At this step, a user output generation module 350 may generate a substitute communication in which the controversial portion of the candidate message is replaced with the suitable replacement language. Returning to the example discussed above, at this step, user output generation module 350 of controversial language mitigation program 150 would replace the controversial portion of the original candidate message of “Greatest day in the history of mankind” to generate a substitute communication reading “Greatest day in the history of humankind”. User output generation module 350 of controversial language mitigation program 150 may then output the generated substitute communication to the user in any suitable format and through any suitable channel. In embodiments, the user may then select whether to accept or reject the output substitute communication.

In embodiments, controversial language mitigation program 150 may further include a feedback module 360. If a given output substitute communication is accepted by a user, this may be understood as a validation of the recommendation, whereas a rejection would be considered as a negative example. Feedback module 360 may be configured to send data related to this type of user feedback back to knowledgebase 330 to continuously update and improve the processes described above.

It may be appreciated that controversial language mitigation program 150 has thus provided improved predicting and mitigating of controversial language in digital communications by leveraging predictive AI and machine learning models to alert users about predicted controversial language, while also actively mitigating the use of the controversial language by identifying suitable replacement language and generating substitute communications that a user may optionally choose to publish in place of the candidate message containing the predicted controversial language. Described embodiments may further provide users with explainability related to the predicted controversial language based on information from an accessible knowledgebase that leverages language features as well as a user's network-specific features that may vary based on language, culture, or environment. Described embodiments may further incorporate feedback modules to leverage user feedback as validation or as a negative example to improve future performance of the applicable models.

It may be appreciated that FIGS. 2-5 provide only illustrations of an exemplary implementation and does not imply any limitations with regard to how different embodiments may be implemented. Many modifications to the depicted environment may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of predicting and mitigating controversial language in digital communication, the method comprising:
detecting language within a candidate communication associated with a user and a corresponding user network;
interpreting the detected language to identify a series of predetermined controversial traits;
calculating an impact risk score for the candidate communication by using a graph neural network to leverage the identified series of predetermined controversial traits and historical data within an accessible knowledgebase, wherein the impact risk score is based on a risk associated with the detected language and the corresponding user network;
in response to detecting the calculated impact risk score for the candidate communication being above a predetermined threshold value, automatically identifying suitable replacement language for one or more controversial portions of the candidate communication; and
generating and outputting to the user one or more substitute communications including the identified suitable replacement language.

2. The computer-based method of claim 1, wherein the accessible knowledgebase includes historical data comprising one or more of communications, associated comments, and associated user interactions.

3. The computer-based method of claim 1, further comprising:
collecting user feedback data on the generated substitute communications; and
sending the collected user feedback data to the accessible knowledgebase.

4. The computer-based method of claim 1, wherein interpreting the detected language to identify the series of predetermined controversial traits further comprises:
utilizing at least one or more of text classification techniques, entity extraction, named entity recognition techniques, neuro-symbolic approaches for text-based policy learning, and latent Dirichlet allocation models.

5. The computer-based method of claim 2, wherein the historical data further comprises the corresponding user network data including one or more of user ego networks, user profiles, post topics, and post categories.

6. The computer-based method of claim 2, wherein automatically identifying the suitable replacement language for the one or more controversial portions of the candidate communication further comprises:
projecting the one or more controversial portions of the candidate communication and terms from the historical data onto an embedding space; and
determining a series of semantically similar projections to determine the suitable replacement language for the one or more controversial portions of the candidate communication.

7. The computer-based method of claim 6, wherein embeddings for the projected one or more controversial portions of the candidate communication and terms from the historical data are generated by leveraging at least one of Word2Vec, Global Vectors (GloVe), Bidirection Encoder Representations from Transformers (BERT), and Visual Bidirection Encoder Representations from Transformers (VisualBERT) models.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
detecting language within a candidate communication associated with a user and a corresponding user network;
interpreting the detected language to identify a series of predetermined controversial traits;
calculating an impact risk score for the candidate communication by using a graph neural network to leverage the identified series of predetermined controversial traits and historical data within an accessible knowledgebase, wherein the impact risk score is based on a risk associated with the detected language and the corresponding user network;
in response to detecting the calculated impact risk score for the candidate communication being above a predetermined threshold value, automatically identifying suitable replacement language for one or more controversial portions of the candidate communication; and
generating and outputting to the user one or more substitute communications including the identified suitable replacement language.

9. The computer system of claim 8, wherein the accessible knowledgebase includes historical data comprising one or more of communications, associated comments, and associated user interactions.

10. The computer system of claim 8, further comprising:
collecting user feedback data on the generated substitute communications; and
sending the collected user feedback data to the accessible knowledgebase.

11. The computer system of claim 8, wherein interpreting the detected language to identify the series of predetermined controversial traits further comprises:
utilizing at least one or more of text classification techniques, entity extraction, named entity recognition techniques, neuro-symbolic approaches for text-based policy learning, and latent Dirichlet allocation models.

12. The computer system of claim 9, wherein the historical data further comprises the corresponding user network data including one or more of user ego networks, user profiles, post topics, and post categories.

13. The computer system of claim 9, wherein automatically identifying the suitable replacement language for the one or more controversial portions of the candidate communication further comprises:
projecting the one or more controversial portions of the candidate communication and terms from the historical data onto an embedding space; and
determining a series of semantically similar projections to determine the suitable replacement language for the one or more controversial portions of the candidate communication.

14. The computer system of claim 13, wherein embeddings for the projected one or more controversial portions of the candidate communication and terms from the historical data are generated by leveraging at least one of Word2Vec, Global Vectors (GloVe), Bidirection Encoder Representations from Transformers (BERT), and Visual Bidirection Encoder Representations from Transformers (VisualBERT) models.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
detecting language within a candidate communication associated with a user and a corresponding user network;
interpreting the detected language to identify a series of predetermined controversial traits;
calculating an impact risk score for the candidate communication by using a graph neural network to leverage the identified series of predetermined controversial traits and historical data within an accessible knowledgebase, wherein the impact risk score is based on a risk associated with the detected language and the corresponding user network;
in response to detecting the calculated impact risk score for the candidate communication being above a predetermined threshold value, automatically identifying suitable replacement language for one or more controversial portions of the candidate communication; and
generating and outputting to the user one or more substitute communications including the identified suitable replacement language.

16. The computer program product of claim 15, wherein the accessible knowledgebase includes historical data comprising one or more of communications, associated comments, and associated user interactions.

17. The computer program product of claim 15, further comprising:
collecting user feedback data on the generated substitute communications; and
sending the collected user feedback data to the accessible knowledgebase.

18. The computer program product of claim 15, wherein interpreting the detected language to identify the series of predetermined controversial traits further comprises:
utilizing at least one or more of text classification techniques, entity extraction, named entity recognition techniques, neuro-symbolic approaches for text-based policy learning, and latent Dirichlet allocation models.

19. The computer program product of claim 16, wherein the historical data further comprises the corresponding user network data including one or more of user ego networks, user profiles, post topics, and post categories.

20. The computer program product of claim 16, wherein automatically identifying the suitable replacement language for the one or more controversial portions of the candidate communication further comprises:
projecting the one or more controversial portions of the candidate communication and terms from the historical data onto an embedding space; and
determining a series of semantically similar projections to determine the suitable replacement language for the one or more controversial portions of the candidate communication.
